(19) United States
(12) Patent Application Publication
(10) Pub. No.: US 2026/0027858 A1
(43) Pub. Date: Jan. 29, 2026

(54) ACTIVE CONTACT PRESSURE CONTROL WHEEL STRUCTURE AND VEHICLE

(71) Applicant: NATIONAL TSING HUA UNIVERSITY, HSINCHU (TW)

(72) Inventors: Jen-Yuan CHANG, HSINCHU (TW); Yen-Hung LIN, HSINCHU (TW)

(21) Appl. No.: 18/901,072

(22) Filed: Sep. 30, 2024

(30) Foreign Application Priority Data
Jul. 23, 2024 (TW) 113127606

(51) Int. Cl. B60C 23/00

(52) U.S. Cl. CPC B60C 23/00318; B60C 23/00336

(57) ABSTRACT

An active contact pressure control wheel structure includes an axle, an axle barrel, a rim, an outer tire, at least two inflation inner tubes, at least two gas output pipe assemblies, and at least two gas input pipe assemblies. The axle includes at least two axial output passages and at least two first radial passages. The axle barrel sleeves on an outside of the axle and includes at least two axial input passages, at least two annular passages, and at least two second radial passages. A gas flows into or flows out from each inflation inner tube via each gas input pipe assembly, each axial input passage, each second radial passage, each annular passage, each first radial passage and each axial output passage to allow the at least two inflation inner tubes to have different pressures, thereby adjusting a shape of the outer tire.

### RELATED APPLICATIONS

This application claims priority to Taiwan Application Serial Number 113127606, filed July 23, 2024, which is herein incorporated by reference.

### BACKGROUND

### Technical Field

The present disclosure relates to a control wheel structure and a vehicle. More particularly, the present disclosure relates to an active contact pressure control wheel structure which is inflatable and a vehicle.

### Description of Related Art

Vehicles are common transportation tools in daily life. The vehicle includes wheels for contacting a ground. As the vehicle is moving, uneven pressure between the wheel and the ground may occur. Specially, values of a velocity, a load and a friction force, and a direction change may cause an uneven pressure distribution, and a linkage configuration of the suspension system may work with the pressure.

The uneven pressure between the wheel and the ground may lead to uneven wear and tear of an outer tire of the wheel, which may lower wheel motion characters such as a friction force, a self-aligning torque, a yawing stability and a vertical stability. Therefore, an improvement is required.

### SUMMARY

According to one aspect of the present disclosure, an active contact pressure control wheel structure includes an axle, an axle barrel, a rim, an outer tire, at least two inflation inner tubes, at least two gas output pipe assemblies, and at least two gas input pipe assemblies. The axle has an axis and includes an axle body, a first central bore penetrating the axle body, at least two axial output passages disposed at the axle body along the axis and surrounding the first central bore, and at least two first radial passages. Each of the axial output passages includes an output opening end and an output closing end, and each of the output opening ends faces toward an axle body rear end of the axle body. Each of the first radial passages is disposed at the axle body and is communicated with each of the axial output passages. The axle barrel sleeves on an outside of the axle and includes a barrel body, a second central bore penetrating the barrel body and configured for the axle to insert therein, at least two axial input passages disposed at the barrel body along the axis and surrounding the second central bore, at least two annular passages disposed at the barrel body and aligned parallelly along the axis, and at least two second radial passages. Each of the axial input passages includes an input opening end and an input closing end, and each of the input opening ends faces toward a barrel body front end of the barrel body. The at least two annular passages are located between the at least two axial input passages and the second central bore along a radial direction, and each of the annular passages corresponds to each of the first radial passages. Each of the second radial passages is disposed at the barrel body and is communicated with each of the axial input passages and each of the annular passages. The rim sleeves on an outside of the axle barrel. The outer tire is disposed at the rim. The at least two inflation inner tubes are located between the outer tire and the rim and are aligned parallelly along the axis, and each of the inflation inner tubes includes a nozzle. Each of the gas output pipe assemblies is connected to each of the nozzles and the output opening end of each of the axial output passages. Each of the gas input pipe assemblies is connected to the input opening end of each of the axial input passages. A gas flows into or flows out from each of the inflation inner tubes via each of the gas input pipe assemblies, each of the axial input passages, each of the second radial passages, each of the annular passages, each of the first radial passages and each of the axial output passages to allow the at least two inflation inner tubes to have different pressures, thereby adjusting a shape of the outer tire.

According to another aspect of the present disclosure, a vehicle includes a vehicle body, four active contact pressure control wheel structures as abovementioned disposed at the vehicle body, and a gas controlling module disposed at the vehicle body and communicated with the at least two gas input pipe assemblies of each of the active contact pressure control wheel structures. The gas controlling module inflates or deflates each of the active contact pressure control wheel structures to control the shape of each of the outer tires.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional schematic view of an active contact pressure control wheel structure according to one embodiment of the present disclosure.

FIG. 2 is a partial exploded view of the active contact pressure control wheel structure of FIG. 1.

FIG. 3 is a three-dimensional schematic view of an axle, an axle barrel, an axle cover and three gas output pipe assemblies of the active contact pressure control wheel structure of FIG. 1.

FIG. 4 is an exploded view of the axle, the axle barrel, the axle cover and the three gas output pipe assemblies of FIG. 3.

FIG. 5 is one partial cross-sectional view of the active contact pressure control wheel structure of FIG. 1.

FIG. 6 is another partial cross-sectional view of the active contact pressure control wheel structure of FIG. 1.

FIG. 7 is three-dimensional view of the active contact pressure control wheel structure of FIG. 1 and a testing device.

FIG. 8 is a schematic view of a vehicle according to another embodiment of the present disclosure.

### DETAILED DESCRIPTION

The embodiments of the present disclosure will be illustrated with drawings hereinafter. In order to clearly describe the content, many practical details will be mentioned with the description hereinafter. However, it will be understood by the reader that the practical details will not limit the present disclosure. In other words, in some embodiment of the present disclosure, the practical details are not necessary. Additionally, in order to simplify the drawings, some conventional structures and elements will be illustrated in the drawings in a simple way; the repeated elements may be labeled by the same or similar reference numerals.

In addition, the terms first, second, third, etc. are used herein to describe various elements or components, these elements or components should not be limited by these terms. Consequently, a first element or component discussed below could be termed a second element or component. Moreover, the combinations of the elements, the components, the mechanisms and the modules are not well-known, ordinary or conventional combinations, and whether the combinations can be easily completed by the one skilled in the art cannot be judged based on whether the elements, the components, the mechanisms or the module themselves are well-known, ordinary or conventional.

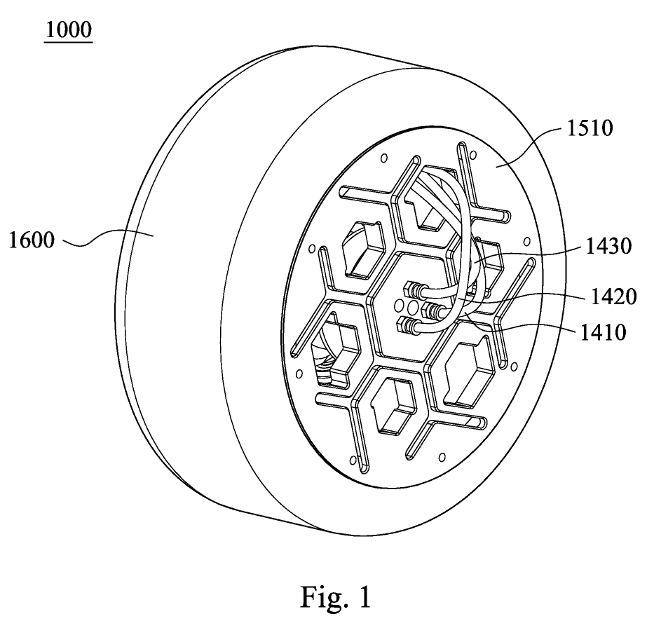

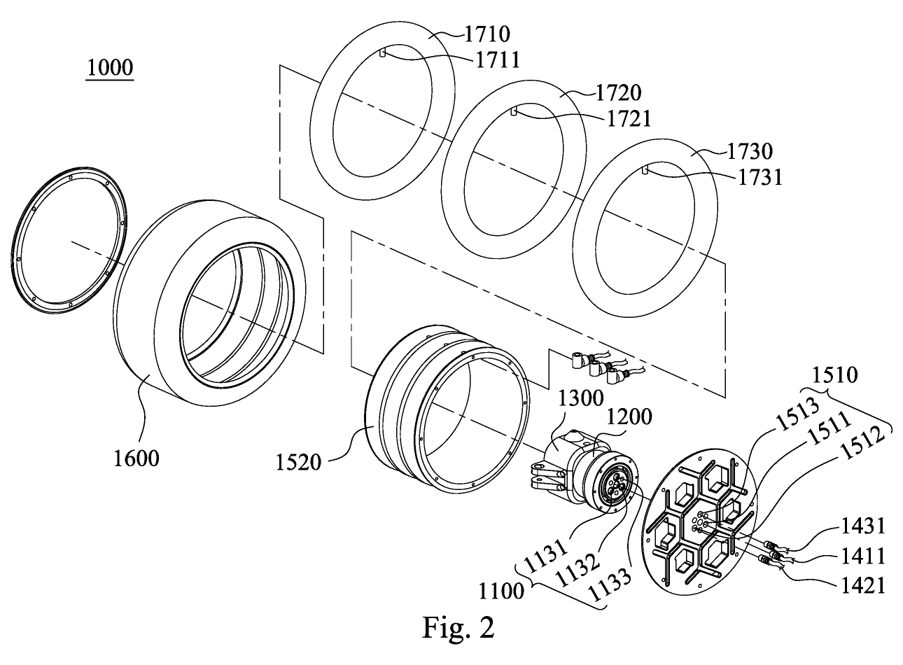

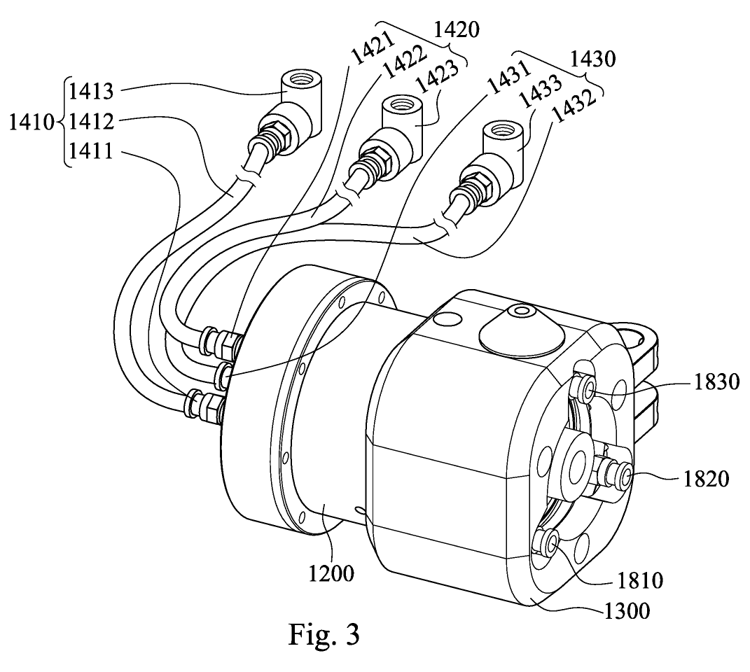

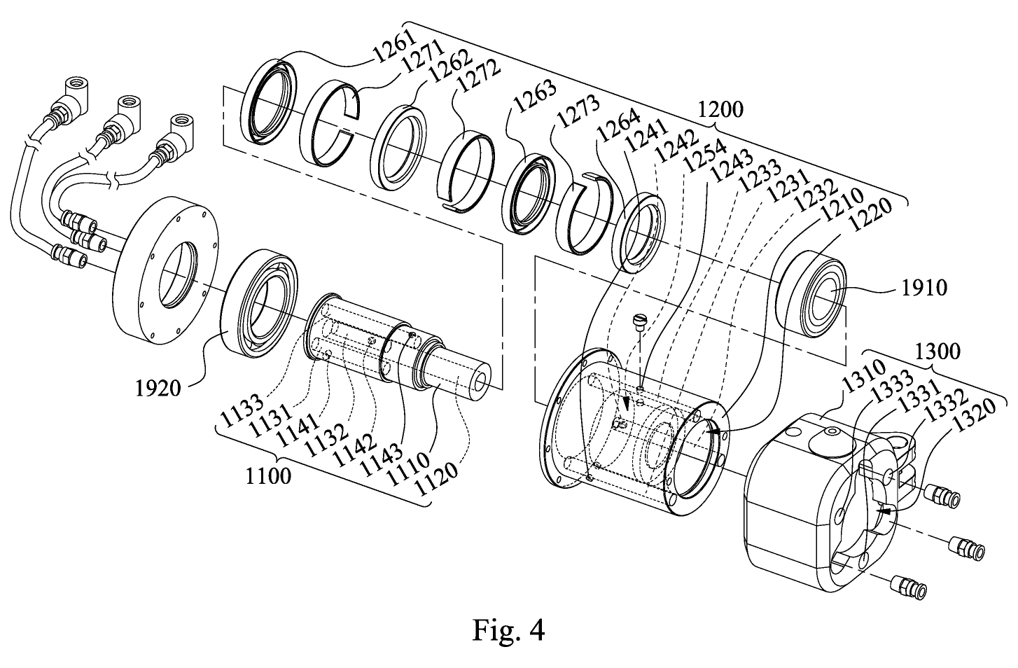

FIG. 1 is a three-dimensional schematic view of an active contact pressure control wheel structure 1000 according to one embodiment of the present disclosure. FIG. 2 is a partial exploded view of the active contact pressure control wheel structure 1000 of FIG. 1. FIG. 3 is a three-dimensional schematic view of an axle 1100, an axle barrel 1200, an axle cover 1300 and three gas output pipe assemblies 1410, 1420, 1430 of the active contact pressure control wheel 1000 structure of FIG. 1. FIG. 4 is an exploded view of the axle 1100, the axle barrel 1200, the axle cover 1300 and the three gas output pipe assemblies 1410, 1420, 1430 of FIG. 3. The active contact pressure control wheel structure 1000 includes the axle 1100, the axle barrel 1200, a rim 1520, an outer tire 1600, at least two inflation inner tubes 1710, 1720, 1730, at least two gas output pipe assemblies 1410, 1420, 1430, and at least two gas input pipe assemblies 1810, 1820, 1830. In the present embodiment, a number of the inflation inner tubes 1710, 1720, 1730, a number of the gas output pipe assemblies 1410, 1420, 1430, and a number of the gas input pipe assemblies 1810, 1820, 1830 are the same and are three for example.

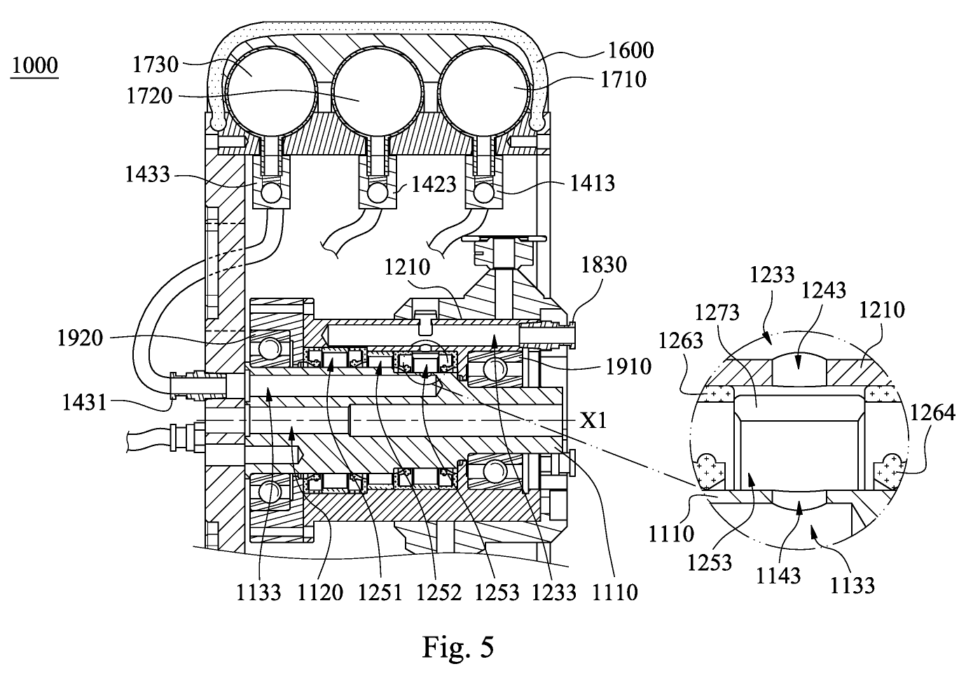

The axle 1100 has an axis X1 (labeled in FIG. 5) and includes an axle body 1110, a first central bore 1120 penetrating the axle body 1110, at least two axial output passages 1131, 1132, 1133 disposed at the axle body 1110 along the axis X1 and surrounding the first central bore 1120, and at least two first radial passages 1141, 1142, 1143. In the present embodiment, a number of the axial output passages 1131, 1132, 1133 and a number of the first radial passages 1141, 1142, 1143 are three for example. Each of the axial output passages 1131, 1132, 1133 includes an output opening end and an output closing end, and each of the output opening ends faces toward an axle body rear end of the axle body 1110. Each of the first radial passages 1141, 1142, 1143 is disposed at the axle body 1110 and is communicated with each of the axial output passages 1131, 1132, 1133.

The axle barrel 1200 sleeves on an outside of the axle 1100 and includes a barrel body 1210, a second central bore 1220 penetrating the barrel body 1210 and configured for the axle 1100 to insert therein, at least two axial input passages 1231, 1232, 1233 disposed at the barrel body 1210 along the axis X1 and surrounding the second central bore 1220, at least two annular passages 1251, 1252, 1253 (labeled in FIG. 5) disposed at the barrel body 1210 and aligned parallelly along the axis X1, and at least two second radial passages 1241, 1242, 1243. In the present embodiment, a number of the axial input passages 1231, 1232, 1233, a number of the annular passages 1251, 1252, 1253, and a number of the second radial passages 1241, 1242, 1243 are three for example. Each of the axial input passages 1231, 1232, 1233 includes an input opening end and an input closing end, and each of the input opening ends faces toward a barrel body front end of the barrel body 1210. The three annular passages 1251, 1252, 1253 are located between the three axial input passages 1231, 1232, 1233 and the second central bore 1220 along a radial direction, and each of the annular passages 1251, 1252, 1253 corresponds to each of the first radial passages 1141, 1142, 1143. Each of the second radial passages 1241, 1242, 1243 is disposed at the barrel body 1210 and is communicated with each of the axial input passages 1231, 1232, 1233 and each of the annular passages 1251, 1252, 1253.

The rim 1520 sleeves on an outside of the axle barrel 1200. The outer tire 1600 is disposed at the rim 1520. The three inflation inner tubes 1710, 1720, 1730 are located between the outer tire 1600 and the rim 1520 and are aligned parallelly along the axis X1, and each of the inflation inner tubes 1710, 1720, 1730 includes a nozzle 1711, 1721, 1731. Each of the gas output pipe assemblies 1410, 1420, 1430 is connected to each of the nozzles 1711, 1721, 1731 and the output opening end of each of the axial output passages 1131, 1132, 1133. Each of the gas input pipe assemblies 1810, 1820, 1830 is connected to the input opening end of each of the axial input passages 1231, 1232, 1233. A gas flows into or flows out from each of the inflation inner tubes 1710, 1720, 1730 via each of the gas input pipe assemblies 1810, 1820, 1830, each of the axial input passages 1231, 1232, 1233, each of the second radial passages 1241, 1242, 1243, each of the annular passages 1251, 1252, 1253, each of the first radial passages 1141, 1142, 1143 and each of the axial output passages 1131, 1132, 1133 to allow the three inflation inner tubes 1710, 1720, 1730 to have different pressures, thereby adjusting a shape of the outer tire 1600.

Therefore, with configuring at least two inflatable inflation inner tubes 1710, 1720, 1730 which are inflatable, the shape of the outer tire 1600 may be adjusted. Moreover, with the configuration of the annular passages 1251, 1252, 1253, that the inflation inner tubes 1710, 1720, 1730 may be inflated during rotating of the axle 1100 to adjust the shape of the outer tire 1600 in real time is ensured. Therefore, a driving safety is increased.

As shown in FIGS. 1 to 3, the rim 1520 is ring-shaped and includes three positioning grooves and three through holes. Each of the positioning grooves is configured to position each of the inflation inner tubes 1710, 1720, 1730, and each of the three through holes is configured to allow each of the nozzles 1711, 1721, 1731 to extend therethrough. The active contact pressure control wheel structure 1000 may further include a spoke board 1510 disposed at the axle body rear end and connected to the rim 1520. The spoke board 1510 includes three board holes 1511, 1512, 1513, and each of the board holes 1511, 1512, 1513 is communicated with each of the axial output passages 1131, 1132, 1133. Each of the gas output pipe assemblies 1410, 1420, 1430 includes an output connector 1411, 1421, 1431, a pipe 1412, 1422, 1432 and a nozzle plug 1413, 1423, 1433. Each of the output connectors 1411, 1421, 1431 is plugged into each of the board holes 1511, 1512, 1513, and each of the nozzles plugs 1413, 1423, 1433 are plugged into each of the nozzles 1711, 1721, 1731. Therefore, as the axle 1100 rotates, the spoke board 1510, the rim 1520, the inflation inner tubes 1710, 1720, 1730 and the outer tire 1600 are rotated. In addition, since the gas output pipe assemblies 1410, 1420, 1430 may be rotated simultaneously, the inflation inner tubes 1710, 1720, 1730 may be inflated or deflated during rotation.

The outer tire 1600 is also ring-shaped. The outer tire 1600 includes fewer carcass ply layers, and thus the outer tire 1600 has flexibility. Consequently, as the three inflation inner tubes 1710, 1720, 1730 include different pressure, the shape of the outer tire 1600 may be changed correspondingly to a cone shape whose cross section a trapezoid.

As shown in FIGS. 3 and 4, the axle body 1110 of the axle 1100 is solid, and the first central bore 1120 penetrates a center of the axle body 1110. Each of the axial output passages 1131, 1132, 1133 is a blind hole going from the axle body rear end toward an axle body rear end. The axle 1100 may further include a plurality of locking holes disposed at the axle body 1110. The locking holes and the axial output passages 1131, 1132, 1133 are staggered to form an annular shape for surrounding the first central bore 1120. The locking holes are configured to fasten with the spoke board 1510. Each of the first radial passages 1141, 1142, 1143 is a hole going from an outer surface toward each the axial output passages 1131, 1132, 1133. Distances between the first radial passages 1141, 1142, 1143 and a front end surface of the axle body front end along the axis A1 are different. Distances of the axial output passages 1131, 1132, 1133 along the axis X1 may be different, but requires that the axial output passage 1131 is communicated with the first radial passage 1141, the axial output passage 1132 is communicated with the first radial passage 1142, and the axial output passage 1133 is communicated with the first radial passage 1143.

The barrel body 1210 is hollow and includes the second central bore 1220 penetrating a center thereof. The axle barrel 1200 may further include an inner annular groove 1254 and at least two sealing rings 1261, 1262, 1263, 1264. The inner annular groove 1254 surrounds and communicates with the second central bore 1220. The at least two sealing rings 1261, 1262, 1263, 1264 are disposed in the inner annular groove 1254 at intervals along the axis X1 so as to split an inner space of the inner annular groove 1254 into the three annular passages 1251, 1252, 1253.

To be more specific, the barrel body 1210 is recessed radially outward in the middle of the second central bore 1220, thereby forming the inner annular groove 1254 surrounding and communicating with the second central bore 1220. A number of the sealing rings 1261, 1262, 1263, 1264 is four and the sealing rings 1261, 1262, 1263, 1264 are arranged from a barrel body rear end toward the barrel body front end in order. Therefore, the annular passage 1251 is formed between the sealing ring 1261 and the sealing ring 1262, the annular passage 1252 is formed between the sealing ring 1262 and the sealing ring 1263, and the annular passage 1253 is formed between the sealing ring 1263 and the sealing ring 1264. In other embodiments, two sealing rings may be used to form three annular passages. Two or more sealing rings may be used as long as the annular passages of required quantity may be formed, and the present disclosure is not limited thereto.

FIG. 5 is one partial cross-sectional view of the active contact pressure control wheel structure 1000 of FIG. 1. Please referring to FIG. 5 with references of FIGS. 2 to 4, the axle barrel 1200 may further include at least two C-shaped pads 1271, 1272, 1273. Each of the C-shaped pads 1271, 1272, 1273 is located in each of the annular passages 1251, 1252, 1253 and includes an aperture. Each of the apertures corresponds to each of the second radial passages 1241, 1242, 1243. As shown in FIGS. 4 to 5, a number of the C-shaped pads 1271, 1272, 1273 is three. The C-shaped pad 1271 is located in the annular passage 1251 with that the opening thereof corresponds to the second radial passage 1241. The C-shaped pad 1272 is located in the annular passage 1252 with that the opening thereof corresponds to the second radial passage 1242. The C-shaped pad 1273 is located in the annular passage 1253 with that the opening thereof corresponds to the second radial passage 1243. Therefore, each of the axial output passages 1131, 1132, 1133 and each of the second radial passages 1241, 1242, 1243 are communicated with each of the annular passages 1251, 1252, 1253.

The active contact pressure control wheel structure 1000 may further include an axle cover 1300 covering the barrel body front end. The axle cover 1300 includes a cover body 1310, a third central bore 1320 penetrating the cover body 1310 and configured for the axle 1100 to extend therethrough, and at least two cover passages 1331, 1332, 1333 surrounding the third central bore 1320. Each of the cover passages 1331, 1332, 1333 corresponds to each of the axial input passages 1231, 1232, 1233. Each of the cover passages 1331, 1332, 1333 may be recessed outward from the third central bore 1320 and is communicated with the third central bore 1320. Each of the gas input pipe assemblies 1810, 1820, 1830 is inserted into each of the cover passages 1331, 1332, 1333 for allowing the gas to flow into or flow out from each pf the axial input passages 1231, 1232, 1233.

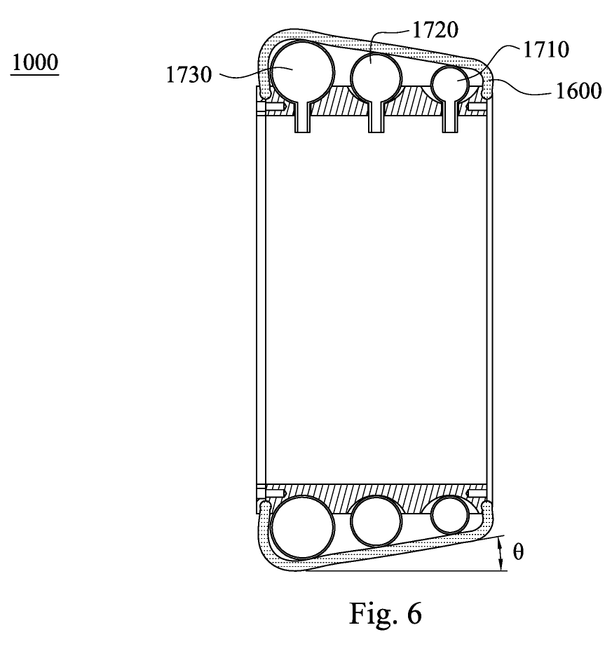

FIG. 6 is another partial cross-sectional view of the active contact pressure control wheel structure 1000 of FIG. 1. Please refer to FIG. 6 with references of FIGS. 2 to 5. The gas may flow into the axial output passage 1133 via the gas input pipe assembly 1830, the axial input passage 1233, the second radial passage 1243, the annular passage 1253 and the first radial passage 1143. Hence, the inflation inner tube 1730 may be inflated or deflated via the gas output pipe assembly 1430. The way to inflate or deflate the inflation inner tube 1710 or the inflation inner tube 1720 is the same, and the details will not be repeated. Hence, with adjusting the pressures of the inflation inner tubes 1710, 1720, 1730, the pressures ranking from large to small in order is that the inflation inner tubes 1730, the inflation inner tubes 1720 and the inflation inner tubes 1710 for example, the shape of the outer tire 1600 is cone-shaped as shown in FIG. 6, and an angle θ is contained between an outer tire surface and a horizontal line parallel to the axis X1.

Moreover, the active contact pressure control wheel structure 1000 may further include two bearings 1910, 1920 respectively and intervally sleeving on the outside of the axle 1100 and located inside the axle barrel 1200. The bearing 1910 sleeves on the axle body front end, the bearing 1920 sleeves on the axle body rear end, and thus the axle barrel 1200 may rotate relative to the axle 1100.

In the structure shown in FIGS. 1 to 6, the gas may be provided by fixing ends, i.e., the gas input pipe assemblies 1810, 1820, 1830 inserted in the axle cover 1300, the axial input passage 1231, 1232, 1233 and the annular passages 1251, 1252, 1253 of the axle barrel 1200, to rotating ends, i.e., the axial output passages 1131, 1132, 1133 of the axle 1100. Since the annular passages 1251, 1252, 1253 surrounds the axle 1100, each of the annular passages 1251, 1252, 1253 may be communicated with the first radial passages 1141, 1142, 1143 as the axle 1100 rotates, thereby increasing a stability for inflation and deflation. Moreover, because the axial output passage 1131 is eccentric, no other transmission gear box is required for a central motor which may be employed in the future.

It is noted that, although a number of the elements, e.g., the inflation inner tubes 1710, 1720 1730, is illustrated as three, the number of the inflation inner tubes may be changed according to the demands in other embodiments. A number of the gas input pipe assemblies, a number of the axial input passages, a number of the second radial passages, a number of the annular passages, a number of the first radial passages, a number of the axial output passages and a number of the gas output pipe assemblies may be equal to the number of the inflation inner tubes, and each of the inflation inner tubes may be inflated or deflated independently, but the present disclosure is not limited thereto.

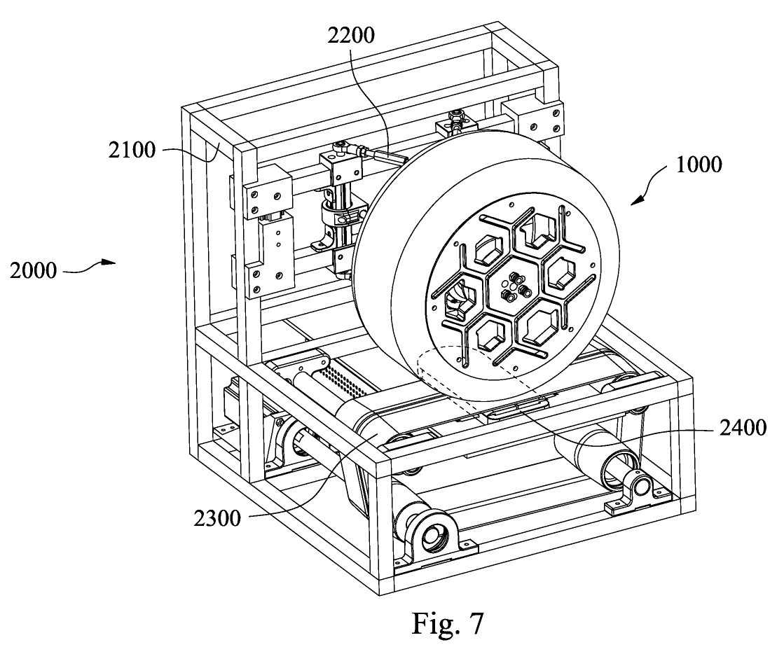

FIG. 7 is three-dimensional view of the active contact pressure control wheel structure 1000 of FIG. 1 and a testing device 2000. The active contact pressure control wheel structure 1000 is tested by the testing device 2000. The testing device 2000 includes a belt 2300 and a pressure sensor 2400. The active contact pressure control wheel structure 1000 contacts the belt 2300, and the pressure sensor 2400 corresponds to the active contact pressure control wheel structure 1000 to measure a pressure distribution.

Precisely, the testing device 2000 may include a frame 2100 and a suspension mechanism 2200. The suspension mechanism 2200 is disposed at the frame 2100 to connect to the active contact pressure control wheel structure 1000 for simulating the suspension of a vehicle. The belt 2300 may be disposed at the frame 2100, and the pressure sensor 2400 may be disposed at the frame 2100 and is located under the belt 2300.

The active contact pressure control wheel structure may contact the ground to generate a surface pressure during moving. The factor of the surface pressure is not only the surface shape caused by the taper and the appearance of the active contact pressure control wheel structure, but is also relative to the rigidity of the active contact pressure control wheel structure. In addition, a lateral acceleration of the vehicle will lead to an uneven load of the active contact pressure control wheel structure. The reason that causes the uneven surface pressure is that the distance between the inner side of the active contact pressure control wheel structure and the center of gravity is different from the distance between the outer side of the active contact pressure control wheel structure and the center of gravity. Therefore, as the active contact pressure control wheel structure is compressed to contain an angle owing to the geometric relation, the deformations of the inner side and the outer side of the active contact pressure control wheel structure are different, especially the deformations of the rubber outer tire being different. Consequently, different surface pressures occur. The surface pressure of the outer side of the active contact pressure control wheel structure is higher than the surface pressure of the inner side of the active contact pressure control wheel structure. Accordingly, the tire pressure of the outer of the active contact pressure control wheel structure has to be increased while the tire pressure of the inner side of the active contact pressure control wheel structure has to be decreased, thereby compensating the uneven surface pressure. Due to the geometric reason and the force reason, in order to compensate the pressure of the outer side and the inner side of the active contact pressure control wheel structure, the taper of the active contact pressure control wheel structure has to compensate the camber angle of the active contact pressure control wheel structure, and a requirement of an even surface force of the active contact pressure control wheel structure has to be satisfied.

Hence, with the condition of {[F₁/k(p₁)-δ(p₁)]-[F₂/k(p₂)-δ(p₂)]}/W=∆Ø=0, different gas pressures for the inflation inner tubes may be obtained. W represents a width of the active contact pressure control wheel structure. k(p₁) represents a rigidity function of the active contact pressure control wheel structure. A universal testing machine may be used to test the active contact pressure control wheel structure under different gas pressures, and the K value of the active contact pressure control wheel structure as being compressed, i.e., the rigidity function in a vertical downward direction, may be obtained. δ(p₁) represents a radius variation of the active contact pressure control wheel structure. A caliper may be used to measure the radius of the active contact pressure control wheel structure in different gas pressures. ∆Ø represents the camber angle which can be served as an effective compensation value. Fᵢ represents a force. Accordingly, with adjusting the shape of the outer tire 1600 by inflating or deflating each of the inflation inner tubes 1710, 1720, 1730, the angle θ between the outer tire surface and a horizontal plane is equal to the camber angle ∆Ø.

The active contact pressure control wheel structure 1000 may be rotated on the belt 2300 of the testing device 2000 to simulate moving on the road, and the pressure sensor 2400 may measure the pressure of the active contact pressure control wheel structure 1000 to confirm whether the pressure satisfies the requirement and an effective compensation is achieved. It is noted that, each of the inflation inner tubes 1710, 1720, 1730 may be inflated or deflated during testing in real time, and whether the shape of the outer tire 1600 may be effectively changed in real time is confirmed.

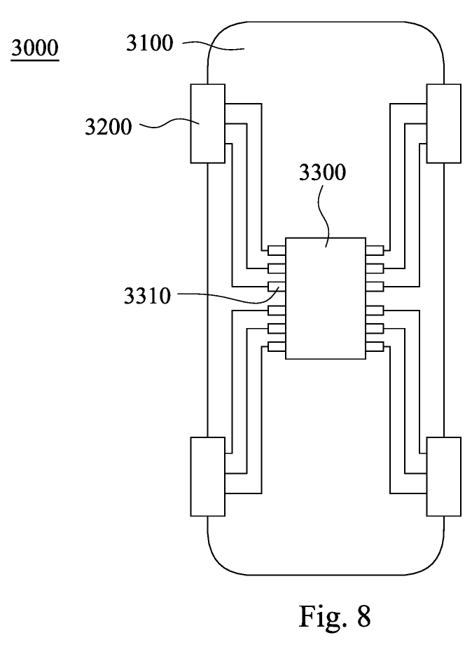

FIG. 8 is a schematic view of a vehicle 3000 according to another embodiment of the present disclosure. The vehicle 3000 includes a vehicle body 3100, four active contact pressure control wheel structures 3200 disposed at the vehicle body 3100, and a gas controlling module 3300 disposed at the vehicle body 3100 and communicated with three gas input pipe assemblies of each of the active contact pressure control wheel structures 3200. The gas controlling module 3300 inflates or deflates each of the active contact pressure control wheel structures 3200 to control the shape of each of the outer tires.

The gas controlling module 3300 may further include at least two proportional valves 3310, and each of the proportional valves 3310 is connected to each of the gas input pipe assemblies. Precisely, the gas controlling module 3300 may further include a gas supply and a controller. Each of the proportional valves 3310 is connected to the gas supply. The controller is signally connected to each of the proportional valves 3310, thereby controlling each of the proportional valves 3310 to inflate or deflate each of the active contact pressure control wheel structures 3200.

Each of the active contact pressure control wheel structures 3200 is similar to the active contact pressure control wheel structure 1000 of FIGS. 1 to 6. With elements such as a gyroscope to measure a camber angle of each of the active contact pressure control wheel structures 3200, the controller may control each of the proportional valves 3310 to adjust the pressure of each of the inflation inner tubes of each of the active contact pressure control wheel structures 3200, thereby compensating the camber angle to balance the force of the outer tire surface.

Based on the aforementioned embodiments, the active contact pressure control wheel structure of the present disclosure has the following advantages. First, with the configuration of the annular passages, that the inflation inner tube can be inflated as the axle is rotated may be ensured, and the shape of the outer tire may be changed in real time to increase the driving stability. Second, with the compensation of the camber angle, the pressure on the tire is even. Third, with the eccentric passages, a space configured for receiving a hub motor is remained. Fourth, with the compensation of the camber angle, the contact surface between the active contact pressure control wheel structure and the ground can be controlled, and a flexibility and tolerance of designing the suspension of the vehicle is increased.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An active contact pressure control wheel structure, comprising:
an axle having an axis and comprising:
an axle body;
a first central bore penetrating the axle body;
at least two axial output passages disposed at the axle body along the axis and surrounding the first central bore, each of the axial output passages comprising an output opening end and an output closing end, wherein each of the output opening ends faces toward an axle body rear end of the axle body; and
at least two first radial passages, each of the first radial passages disposed at the axle body and communicated with each of the axial output passages;
an axle barrel sleeving on an outside of the axle and comprising;
a barrel body;
a second central bore penetrating the barrel body and configured for the axle to insert therein;
at least two axial input passages disposed at the barrel body along the axis and surrounding the second central bore, each of the axial input passages comprising an input opening end and an input closing end, wherein each of the input opening ends faces toward a barrel body front end of the barrel body;
at least two annular passages disposed at the barrel body and aligned parallelly along the axis, the at least two annular passages are located between the at least two axial input passages and the second central bore along a radial direction, each of the annular passages corresponding to each of the first radial passages; and
at least two second radial passages, each of the second radial passages disposed at the barrel body and communicated with each of the axial input passages and each of the annular passages;
a rim sleeving on an outside of the axle barrel;
an outer tire disposed at the rim;
at least two inflation inner tubes located between the outer tire and the rim and aligned parallelly along the axis, each of the inflation inner tubes comprising a nozzle;
at least two gas output pipe assemblies, each of the gas output pipe assemblies connected to each of the nozzles and the output opening end of each of the axial output passages; and
at least two gas input pipe assemblies, each of the gas input pipe assemblies connected to the input opening end of each of the axial input passages;
wherein a gas flows into or flows out from each of the inflation inner tubes via each of the gas input pipe assemblies, each of the axial input passages, each of the second radial passages, each of the annular passages, each of the first radial passages and each of the axial output passages to allow the at least two inflation inner tubes to have different pressures, thereby adjusting a shape of the outer tire.

2. The active contact pressure control wheel structure of claim 1, further comprising a spoke board disposed at the axle body rear end and connected to the rim, wherein the spoke board comprises at least two board holes, each of the board holes is communicated with each of the axial output passages, each of the gas output pipe assemblies comprises an output connector, and each of the output connectors is plugged into each of the board holes.

3. The active contact pressure control wheel structure of claim 1, wherein the axle barrel further comprises an inner annular groove and at least two sealing rings, the inner annular groove surrounds and communicates with the second central bore, the at least two sealing rings are disposed in the inner annular groove at intervals along the axis so as to split an inner space of the inner annular groove into the at least two annular passages.

4. The active contact pressure control wheel structure of claim 3, wherein the axle barrel further comprises at least two C-shaped pads, and each of the C-shaped pads is located in each of the annular passages and comprises an aperture, wherein each of the apertures corresponds to each of the second radial passages.

5. The active contact pressure control wheel structure of claim 3, further comprising an axle cover covering the barrel body front end and comprising:
a cover body;
a third central bore penetrating the cover body and configured for the axle to extend therethrough; and
at least two cover passages surrounding the third central bore, each of the cover passages corresponding to each of the axial input passages.

6. The active contact pressure control wheel structure of claim 1, further comprising two bearings respectively and intervally sleeving on the outside of the axle and located inside the axle barrel.

7. The active contact pressure control wheel structure of claim 1, wherein the active contact pressure control wheel structure is tested by a testing device, the testing device comprises a belt and a pressure sensor, the active contact pressure control wheel structure contacts the belt, and the pressure sensor corresponds to the active contact pressure control wheel structure to measure a pressure distribution.

8. A vehicle, comprising:
a vehicle body;
four active contact pressure control wheel structures of claim 1, disposed at the vehicle body; and
a gas controlling module disposed at the vehicle body and communicated with the at least two gas input pipe assemblies of each of the active contact pressure control wheel structures, the gas controlling module inflating or deflating each of the active contact pressure control wheel structures to control the shape of each of the outer tires.

9. The vehicle of claim 8, wherein the active contact pressure control wheel structure further comprises a spoke board disposed at the axle body rear end and connected to the rim, the spoke board comprises at least two board holes, each of the board holes is communicated with each of the axial output passages, each of the gas output pipe assemblies comprises an output connector, and each of the output connectors is plugged into each of the board holes.

10. The vehicle of claim 9, wherein the axle barrel further comprises an inner annular groove and at least two sealing rings, the inner annular groove surrounds and communicates with the second central bore, the at least two sealing rings are disposed in the inner annular groove at intervals along the axis so as to split an inner space of the inner annular groove into the at least two annular passages.

11. The vehicle of claim 10, wherein the axle barrel further comprises at least two C-shaped pads, each of the C-shaped pads is located in each of the annular passages and comprises an aperture, wherein each of the apertures corresponds to each of the second radial passages.

12. The vehicle of claim 11, wherein the active contact pressure control wheel structure further comprises an axle cover covering the barrel body front end and comprising:
a cover body;
a third central bore penetrating the cover body and configured for the axle to extend therethrough; and
at least two cover passages surrounding the third central bore, each of the cover passages corresponding to each of the axial output passages.

13. The vehicle of claim 12, wherein the active contact pressure control wheel structure further comprises two bearing respectively and intervally sleeving on the outside of the axle and located inside the axle barrel.

14. The vehicle of claim 13, wherein the gas controlling module comprises at least two proportional valves, and each of the proportional valves is connected to each of the gas input pipe assemblies.
